(19) United States
(12) Patent Application Publication
(10) Pub. No.: US 2012/0291700 A1
(43) Pub. Date: Nov. 22, 2012

(54) Lubricating device

(76) Inventor: Dean Coley Thommes, Kalamazoo, MI (US)

(21) Appl. No.: 13/506,684

(22) Filed: May 9, 2012

Related U.S. Application Data
(60) Provisional application No. 61/488,024, filed on May 19, 2011.

(51) Int. Cl. B05C 1/16

(52) U.S. Cl. 118/270

(57) ABSTRACT

A container filled with foam saturated with a lubricant with a relief cut in the top surface of the foam suitable for receiving and lubricating an electrical connection, especially the base of a light bulb.

This application claims the benefit of provisional application No. 61/488,024 filed May 19, 2011, and the specification thereof is incorporated herein by reference.

### FIELD OF INVENTION

This invention relates to a device for lubrication of electrical connections, most especially the base of light bulbs to reduce the chance of breakage when removing bulb from a socket in which it is installed.

### BACKGROUND OF INVENTION

Compact fluorescent light bulbs (CFL) contain small amounts of mercury, a known toxicant. When such a bulb breaks upon removal from a socket, most likely to occur after a long period of use, the extensive clean up guidelines issued from the Environmental Protection Agency (EPA) and manufacturers to prevent contamination and exposure to the mercury are substantial. EPA's instructions for cleaning a broken CFL include four steps before cleanup, seven steps for cleaning hard surfaces, six steps for cleaning carpeting or rugs, and two more steps for future cleaning of carpeting or rugs. Minimizing the possibility of such a cleanup was the stimulus for the present invention.

When the base of a long acting CFL sticks in a receptacle, there is a possibility that the bulb will break and release mercury into the immediate surroundings when the bulb is removed. Sweeping up a broken CFL is much more extensive than sweeping up a shattered incandescent bulb but both cleanups are inconvenient and pose some danger from broken glass itself. While cleanup in either case is not overwhelming, it is desirable to avoid it if it can be done conveniently and inexpensively. The device of provides such a solution to this problem by providing a device for easy lubrication of the base of a bulb before it is installed. The device lubricates and conditions the light bulb base, helps to ease the installation of light bulbs and, most importantly, minimizes the possibility of breakage most commonly associated with seized light bulb bases in sockets.

A patent search including electric plug lubricators, light bulb base lubricators, electric outlet lubricators, lubricating devices, lubrication applicators and lubrication devices found the following U.S. patents and one published patent application: U.S. Pat. Nos. 1,421,681; 2,367,721; 2,404,052; 2,430,731; 2,680,449; 3,012,109; 3,642,098; 4,023,648; 5,205,378; 5,181,585; 6,070,697; 6,247,555; and 2006/0173405. None of the foregoing patents disclose a product remotely similar to the device of the present invention, much less as convenient to use or economical to make. None disclose the application of a lubricant directly to the base of a light bulb.

The above identified provisional application was preceded by design patents U.S. D614,574 and D633,870 with the same inventor as the present application but are directed to an ornamental design which is not suitable as pictured for lubricating the base of a light bulb, albeit the D633,870 patent does state that the design is for “a electric plug and light bulb base lubricator”. However the openings in the top surface of the design are not suitable for lubricating a light bulb base. Moreover it does not disclose the other critical features of the present invention as claimed, all of which in combination are necessary features of the present invention as will be disclosed and claimed hereinafter.

### SUMMARY OF INVENTION

The present invention relates to foam inside a container, the foam being saturated with an environmentally acceptable lubricant and having relief cuts in its top surface, the cuts suitable for inserting and lubricating the base of a light bulb by manually turning the base inside the cuts. The container is small enough to hold in one hand while inserting the light bulb base into the foam with the other hand. A container shaped like a cup is preferred. The foam must be capable of saturation with a lubricant and is preferably microcellular for maximum saturation. The lubricant must be stable over long periods of time and is preferably a liquid petroleum derivative coupled with an industrial degreasing solvent to facilitate application of the lubricant to the surface of the base while maintaining maximum electrical contact between the surfaces of a socket and the base. Together the lubricant and solvent must be compatible with the surfaces of the socket and the base and environmentally friendly. The cuts in the top surface of the foam are preferably two in number and arranged to cross at right angles to each other at their midpoints. A hole, smaller than the base of a light bulb, can be provided at the point where the cuts would cross each other to facilitate entry of the base into the foam while providing enough tension on the base to facilitate application of the lubricant.

A preferred embodiment comprises a cup containing foam saturated with a liquid lubricant, the foam sized to fit snugly inside the cup, the cup made of plastic and having a lid with a living hinge opposing a tab to facilitate opening the lid. A user would pop the lid using the tab, insert the base of a bulb into relief cuts in the top surface of the foam, turn the bulb to coat the base of the bulb evenly, and remove the bulb ready for insertion of the base into a socket. The relief cuts are preferably two in number, intersect each other at their midpoints and sized to enable a user to insert an electrical connection, like a light bulb base, and coat it with lubricant. A small hole at the intersection can further ease the connection into the foam. The foam is preferably a microcellular open cell polyurethane. The lubricant is preferably a mixture of a petroleum derivative like mineral oil and an industrial degreasing solvent.

### BRIEF DESCRIPTION OF DRAWINGS

FIG. 1 is a side view of a plastic cup shaped container.

FIG. 2 is a top view of an open container.

FIG. 3 is a top view of the foam showing another version of the relief cuts in the top of the foam.

FIG. 4 is a side view of the container without the attached lid showing an outline of the foam inside the container.

FIG. 5 is a side view of the container with a CFL light bulb pressed into the foam inside the container.

### LIST OF REFERENCE NUMERALS

1 Cup
2 Lid
3 Living hinge
4 Tab
5 Label
6 Foam
7 Relief cuts
8 Hole at the intersection of the cuts
9 CFL light bulb
10 Light bulb base
11 Foam

### DETAILED DESCRIPTION

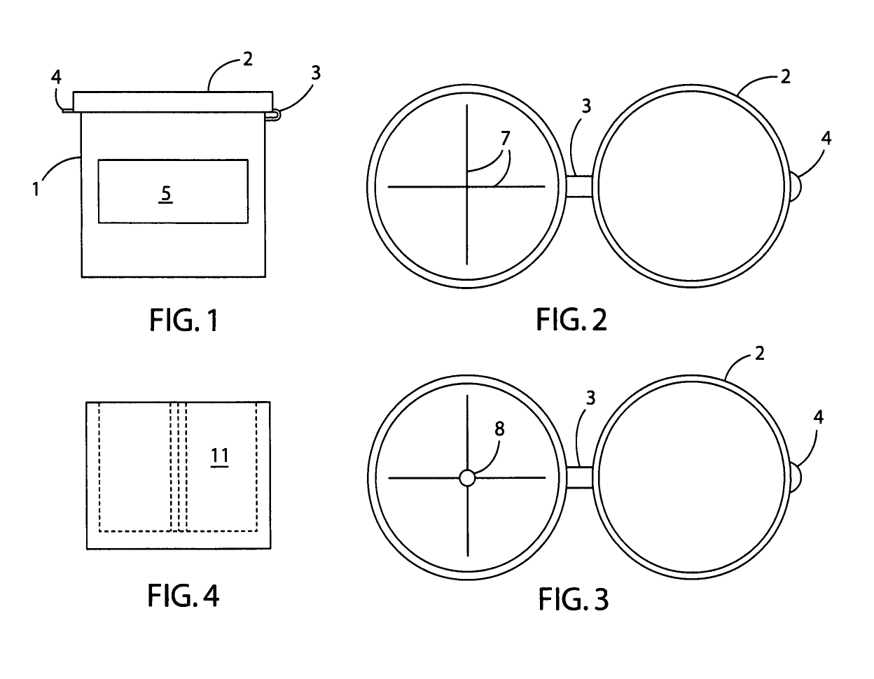

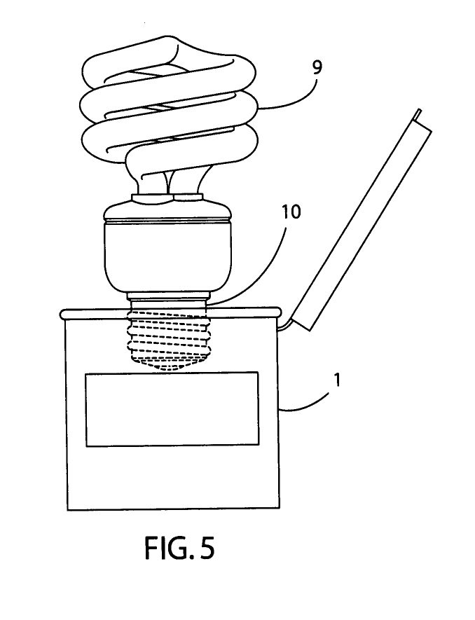

FIG. 1 is a side view of a preferred embodiment of the invention wherein the container 1 is a plastic cup with an intact snap on leak proof lid 2 with a living hinge 3 opposing a tab or lid 4 to facilitate opening the cup. FIG. 2 is a top view of an open cup showing relief cuts 7 in the foam that fills the container 1. FIG. 3 is a top view of the foam showing relief cuts 7 positioned to cross each other at their midpoints with an added hole or opening 8 where the crossing would otherwise take place for use when the electrical connection to be coated is larger than an ordinary appliance. The added hole 8 and the exact shape of the relief cuts 7 are individually preferred embodiments of the relief cuts but not essential features of the present invention. FIG. 4 is a side of the container 1 without a lid and shows an outline of the foam 11 and the hole in the center of the foam 11. FIG. 5 depicts a CFL light bulb 9 with its base 10 inserted in the container 1. Other electrical connectors can also be inserted and coated with lubricant. The preferred foam 11 is open cell polyurethane foam although any comparable foam capable of holding and dispensing an electrical connections lubricant would be acceptable. Such a lubricant provides a long lasting coating and conducts instead of inhibits the passage of electricity.

The preferred lubricant composition used to saturate the foam is a combination of a mineral oil lubricant and n-propyl bromide industrial degreasing solvent. The solvent cleans the surfaces of the electrical connecter while the lubricant is dispensed and ensures better transmission of electrical current after the connector is inserted into a socket or receptacle. Small amounts of ethylene glycol monobutyl ether or nitromethane and 1,2-butylene oxide are sometimes present in suitable penetrating industrial degreasing solvents. A preferred patented solvent containing n-propyl bromide is sold under the name EnSolv which lists U.S. Pat. Nos. 5,616,549, 5,824,162, 5,938,859, 6,176,942 & 6,402,857 in the PRODUCT DESCRIPTION section of its Material Safety Data Sheet. Those patents are incorporated by reference herein. However, any environmentally compatible electrical connections lubricator can be used in the product of the present invention. Likewise any foam capable of being saturated with and thence releasing such a lubricant when contacted with the base of a light bulb can be used in the product of the present invention.

The container 1 is preferably a leak proof plastic compatible with the lubricant ingredients being used. A convenient size and shape for a hand held container 1 is a cup with a diameter and height of 55 millimeters. The product can be molded in one piece or extruded in, or cut from, sheets into separate pieces and reassembled by standard procedures well known to those skilled in the manufacturing arts. The user can insert the base 10 of a light bulb 9 into the opening 8 of the cup into the relief cuts 7 in the foam 6 and turn the bulb 9 to coat the base 10 with lubricant.

The foregoing provides both a general description of the present invention as well as a specific description of preferred embodiments. It should be understood that various substitutions, variations and modifications can be made by those skilled in the art without departing from the spirit and scope of the invention as further delineated in the following claims.

1. A container filled with foam, the foam being saturated with a liquid lubricant and having relief cuts on its top surface to facilitate application of lubricant to an electrical connection when inserted into the foam.

2. The container of claim 1 further comprising the container is made of a leak proof plastic and shaped like a cup having a top connected to a snap on lid by a living hinge, the lid having a tab opposite the hinge to facilitate opening the lid.

3. The container of claim 1 further comprising the relief cuts are two in number, centrally located in the top surface of the foam and intersect each other at right angles at their midpoints.

4. The container of claim 1 further comprising a hole at the midpoints of the two cuts.

5. The container of claim 1 further comprising the foam is a microcellular open cell high density polyurethane.

6. The container of claim 1 further comprising the relief cuts are suitable in size and shape for applying lubricant to the base of a light bulb.

7. The container of claim 1 further comprising the lubricant is a penetrating mixture comprising mineral oil and an industrial degreasing solvent.

8. The container of claim 7 further comprising the industrial degreasing solvent consists essentially of n-propyl bromide.

9. A lubricating device comprising
a. a container adapted to hold in one hand,
b. a microcellular open cell foam filling the container,
c. a liquid lubricant saturating the foam, and
d. relief cuts in the top surface of the foam adapted to coat an electrical connector when inserted into and turned in the foam.

10. The lubricating device of claim 9 further comprising the container is a leak proof plastic shaped cup connected to a snap on lid by with a living hinge, the lid having a tab opposite the hinge to facilitate opening the lid.

11. The lubricating device of claim 9 further comprising the lubricant consists essentially of a petroleum based oil and an industrial degreasing solvent.

12. The lubricating device of claim 11 further comprising the lubricant consists essentially of mineral oil and n-propyl bromide.

13. The lubricating device of claim 9 further comprising a microcellular open cell high density polyurethane foam.
